(19) United States
(12) Patent Application Publication
(10) Pub. No.: US 2009/0255482 A1
(43) Pub. Date: Oct. 15, 2009

(54) PET TOY

(75) Inventor: Paul Santarsiero, Avon, CT (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 12/101,479

(22) Filed: Apr. 11, 2008

(51) Int. Cl. A01K 29/00

(52) U.S. Cl. 119/707

(57) ABSTRACT

A pet toy may include first and second objects. The first object may include a first toy, and the second object may include a second toy. The first and second objects may be selectively joined to form a third toy and selectively disconnected to deconstruct the third toy. The first toy may be a ball or other toy that may be thrown. The second toy may be a plush or non plush toy, which may or may not be stuffed. The first toy may include two bodies that are selectively joined to form the first toy. One body may include a shaft that can be received in an opening defined in the other body to join the bodies to form the first toy. The second toy may include a hole to receive the shaft for joining the first toy to the second toy.

### FIELD OF INVENTION

The present invention generally relates to pet toys, and more particularly to pet toys that attract an animal to the toy and maintain the animal's interest in it.

### BACKGROUND

Pet owners often use pet toys to allow their pets, such as dogs or cats, to engage in natural, yet potentially destructive behaviors such as biting and chewing. For example, when the pet is chewing on a valuable item, the owner may substitute the pet toy for the item, thus allowing the animal to continue to chew on the pet toy while preserving the valuable item from damage or destruction from the animal's chewing. The pet, however, may lose interest in the pet toy and return to its undesired behavior. Thus, it can be useful for a pet owner to have multiple toys available to maintain the pet's interest in a toy rather than have the animal return its interest to an item that the owner would prefer not to be damaged by the pet.

### BRIEF SUMMARY

One embodiment of the present invention may take the form of a pet toy including a first object and a second object. The first object may include a first toy, and the second object may include a second toy. The second object may be selectively joined to the first object to form a third toy and selectively disconnected from the first object to deconstruct the third toy.

Another embodiment of the present invention may take the form of a pet toy including a ball and a plush body. The ball may be selectively joined to the plush body and selectively disconnected from the plush body. In some embodiments, the ball includes a groove and at least a portion of the plush body may be received within the groove when the ball and plush body are joined.

### BRIEF DESCRIPTION OF THE DRAWINGS

FIG. 1 depicts a perspective view of a first embodiment of a pet toy.

FIG. 2 depicts a side elevation view of the pet toy shown in FIG. 1.

FIG. 3 depicts a cross-section view of the pet toy shown in FIG. 1, viewed along line 3-3 in FIG. 1.

FIG. 4 depicts an exploded perspective view of the pet toy shown in FIG. 1.

FIG. 5 depicts a front view of a second example of a pet toy.

FIG. 6 depicts a front view of a third example of a pet toy.

FIG. 7 depicts a front view of a fourth example of a pet toy.

FIG. 8 depicts a front view of a fifth example of a pet toy.

FIG. 9 depicts a front view of a sixth example of a pet toy.

FIG. 10 depicts a front view of a seventh example of a pet toy.

FIG. 11 depicts a front view of a eight example of a pet toy.

FIG. 12 depicts a front view of a ninth example of a pet toy.

FIG. 13 depicts a front view of a tenth example of a pet toy.

FIG. 14 depicts a front view of an eleventh example of a pet toy.

FIG. 15 depicts a front view of a twelfth example of a pet toy.

FIG. 16 depicts a front view of a thirteenth example of a pet toy.

FIG. 17 depicts a front view of a fourteenth example of a pet toy.

FIG. 18 depicts a front view of a fifteenth example of a pet toy.

FIG. 19 depicts a front view of a sixteenth example of a pet toy.

FIG. 20 depicts a front view of a seventeenth example of a pet toy.

FIG. 21 depicts a front view of a eighteenth example of a pet toy.

### DETAILED DESCRIPTION

Described herein are pet toys for use by a pet such as a dog, a cat, or other domesticated animal. The pet toy may take the form of two objects that may be selectively joined to form a single toy and selectively disconnected to form two or more toys. Each object may be formed from one or more materials that are relatively safe for an animal to chew, bite, or lick, such as rubber, plastic, nylon, fabric, or foam. Each object may be composed of one or more of the same or different materials. In some embodiments, one object may be formed from rubber or the like, and the other object may be formed from fabric and a polyester or other type of fill material.

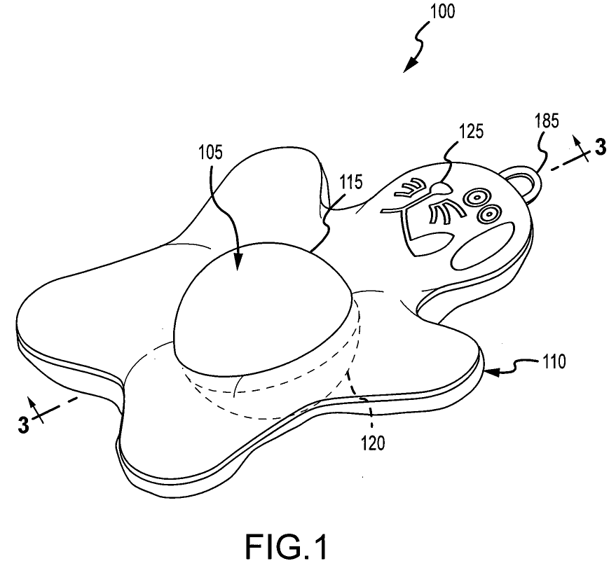

FIGS. 1-4 depict a first embodiment of a pet toy 100. With reference to FIG. 1, which shows a perspective view of the pet toy, the pet toy 100 may include a first object 105 and a second object 110. The first object 105 may be selectively joined and disconnected from the second object 110. When joined, the first and second objects 105, 110 may form a first toy. When disconnected, the first object 105 may form a second toy, and the second object 110 may form a third toy. Thus, a pet owner may change the toy provided to the animal by selectively joining and disconnecting the first and second objects 105, 110.

The first object 105 may include first and second bodies 115, 120. The first object 105, however, may include more than two bodies, if desired. The first and second bodies 115, 120 may be selectively joined and disconnected from each other. When joined, the first and second bodies 115, 120 may form a toy that may be thrown, such as a ball or the like.

Each body 115, 120 may be formed from rubber or the like, or from any material that is generally safe for an animal, including, but not limited to, nylon, plastic, fabric, or some combination of materials. The rubber or other material may be sufficiently flexible to at least somewhat deflect or otherwise move when chewed or bitten by an animal. In other embodiments, the rubber or other material may more rigid to emphasize durability with minimal flexibility.

The second object 110 may be a toy that resembles an animal, a vegetable, a tool or other thing. The toy may be a plush or non-plush body, which may or may not be stuffed. The second object 110 may be formed from fabric or the like, or from any material that is generally safe for an animal, including, but not limited to, nylon, plastic, rubber, or some combination of materials. The second object 110 may include stitching 125, using thread or other suitable material, to form faces, such as a face of a dog as shown, for example, in FIG. 1, or other designs on the second object 110. Designs may also be formed on or in the second object 110 by embossing, stamping or otherwise imprinting such designs. Designs may also be created on the second object 110 using a fabric or other material that is cut or formed into desired shapes or patterns and glued, sewn, or otherwise attached to the second object 110. Designs may also be formed on the second object 110 by screening or otherwise printing them on the second object 110.

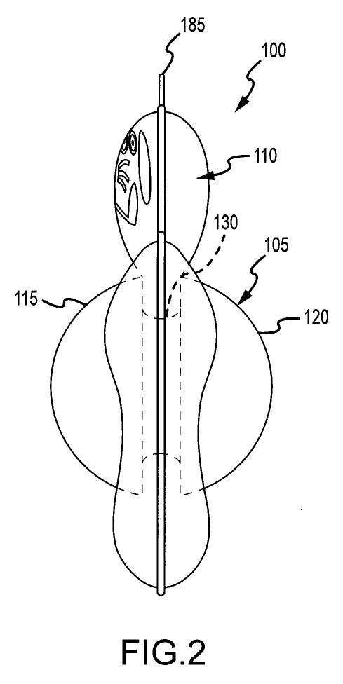

FIG. 2 shows a side elevation view of the pet toy 100 depicted in FIG. 1. With reference to FIG. 2, the first and second bodies 115, 120 of the first object 105 may define a groove 130 or other recessed surface. The groove 130 may extend around a circumference of the first object 105. In some embodiments, the groove 130 may extend around a portion of the circumference of the first object 105, or may be omitted. The groove 130 may be U-shaped or any other suitable shape. At least a portion of the second object 110 may be received within the groove 130 when the first and second objects 105, 110 are joined, thus sandwiching the second object 110 between the separable bodies 115, 120 of the first object 105 to maintain the connection between the first and second objects 105, 110. The groove 130 may also cause the first object 105 to bounce or otherwise move randomly when the first object 105 is thrown or bounced. This random movement may increase the pet's interest in the pet toy 100.

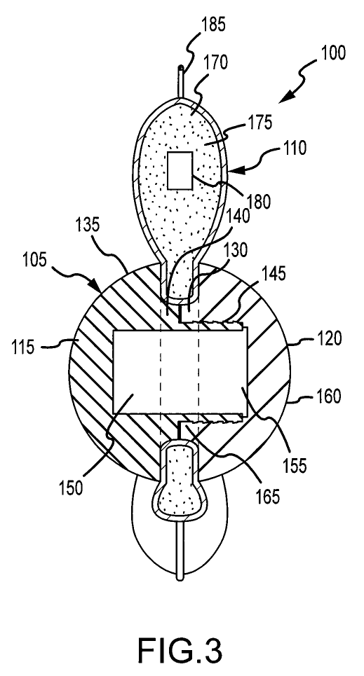

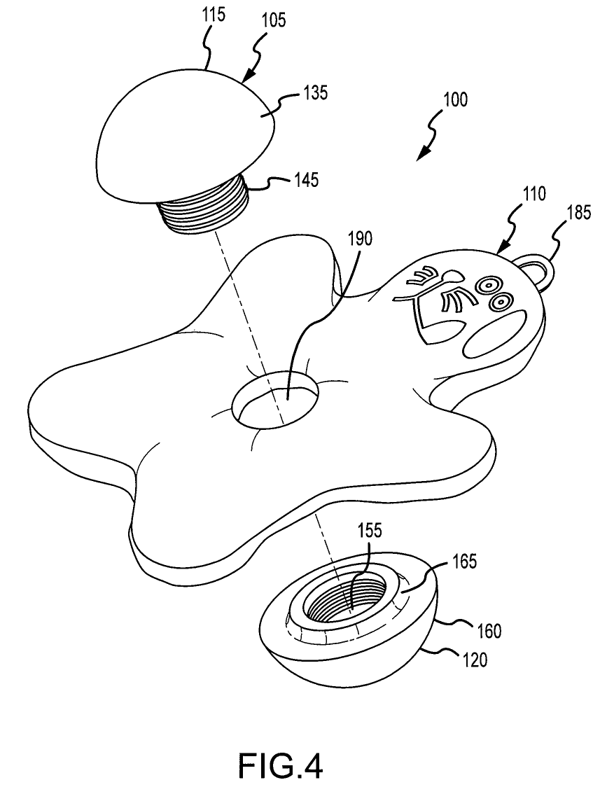

FIGS. 3 and 4 depict respectively a cross-section view and an exploded perspective view of the pet toy 100 shown in FIG. 1. Turning to these figures, the first body 115 of the first object 105 may include a partial spherical first portion 135. A generally annular sidewall 140 may extend from an end of the first portion 135. The sidewall 140 may have a diameter less than a diameter of the first portion 135. A section of a surface of the first portion 135 and a section of a surface of the sidewall 140 may define a part of the groove 130 created by the first and second bodies 115, 120 when joined.

The first body 115 may include a second sidewall 145 or shaft that extends from the first sidewall 140. The second sidewall 145 may be generally cylindrical or any other suitable shape. The second sidewall 145 may have a diameter less than the diameter of the first sidewall 140. Threads may be formed on an outer surface of the second sidewall 145. The threads may be used to threadedly join the first body 115 to the second body 120.

Inner surfaces of the first portion 135, the first sidewall 140, and the second sidewall 145 may define a first open space 150 within the first body 115. The first open space 150 defined by the first body 115 may be generally cylindrical or any other desired shape. In some embodiments, the first open space 150 may be omitted, and thus the first body 115 may be substantially solid. A substantially solid body may be more durable than a body that defines one or more open spaces. A body 115 that defines one or more open spaces as shown, for example, in FIG. 3 may be easier and/or less costly to manufacture.

The first open space 150 may in conjunction with a second open space 155 defined in the second body 120 form a chamber or cavity within the first object 105 when the first and second bodies 115, 120 are joined. One or more items of interest to a pet, such as pet treats, noise makers, cat nip or other odor attractants, and so on, may be placed in the chamber, if desired. Such items may increase a pet's desire to play with the pet toy 100.

Like the first body 115, the second body 120 of the first object 105 may include a partial spherical first portion 160 with an annular sidewall 165 extending from an end of the first portion 160. Also like the first body 115, a section of a surface of the second body first portion 160 and a section of a surface of the second body sidewall 165 may define a part of the groove 130 created by the first and second bodies 115, 120 when joined.

Surfaces of the second body first portion 160 and the second body sidewall 165 may define the second open space 155. The second open space 155 may be generally cylindrical or any other desired shape. The second open space 155 may be sized to receive the second sidewall 145 of the first body 115. The surfaces of the second body first portion 160 and the second body sidewall 165 may be threaded to complement the threads formed the first body 115, thus allowing the first body 115 to be threadedly joined to the second body 120. Although the first and second bodies 115, 120 are shown as threadedly joined to form the first object 105, the first and second bodies 115, 120 may be selectively joined by any known connection method, including, but not limited to, by snaps, hook and loop fasteners, mechanical fasteners, press fit, bayonet connections, and any combination thereof.

One or both bodies 115, 120 may include ridges, indentations, recesses, holes or other shapes formed in or attached to the body 115, 120. The ridges, indentations, recesses or other shapes may be decorative and/or may provide dental cleaning or gum massaging functions. The indentations, recesses or holes may also receive and retain pet treats or other food.

The second object 110 may include two or more sheets of fabric. The fabric may be formed from natural or synthetic materials, including, but not limited to, terry cloth, cotton, wool, polyester, acrylic fiber, velboa, felt or some combination thereof. The fabric sheets may be cut or otherwise shaped to resemble an animal or other thing. The sheets may be joined by stitching, heat welding, any other suitable fabric connection method, or any combination thereof.

The joined sheets may define a second object cavity 170 or other enclosed space. A fill material 175 may be placed in the second object cavity 170. The fill material 175 may be polyester fiber fill, plastic pellets, foam, any other fill material or any combination thereof. The fill material 175 may provide volume to the second object 110 to make it more three-dimensional. The fill material 175 may also provide some resistance to the animal's teeth when it bites or chews on the second object 110. In some embodiments, the fill material 175 may be omitted. Items to attract the animal to the second object 110 may be placed in the second object cavity 170. For example, a noise maker 180, such as the squeaker shown schematically in FIG. 3, may be contained within the second object cavity 170. The foregoing example is merely illustrative and is not intended to limit placement of other known animal attractants in the second object cavity 170.

The second object 110 may include one or more straps or hooks 185. The straps or hooks 185 may be sewn or otherwise attached to the second object 110 proximate an area that defines a head portion of the second object 110 or at any other location on the second object 110. A strap or hook 185 may be formed into one or more loops or the like. The one or more loops may be used to hang the second object 110 (or the first and second objects 105, 110) from any suitable structure, including, but not limited to, a hanger, a belt, or a display rack.

The second object 110 may include a hole 190. The hole 190 may be sized to receive the second sidewall 145 of the first body 115. To join the second object 110 to the first object 105, the second sidewall 145 may be inserted into the hole 190 of the first object 105. The first body 115 of the first object 105 may then be joined to the second body 120 of the first object 105, thus positioning and maintaining the second object 110 between the first and second bodies 115, 120 of the first object 105. To disconnect the first object 105 from the second object 110, the first body 115 of the first object 105 may be disconnected from the second body 120 of the first object 105, and the second sidewall 145 removed from the hole 190 of the second body 120. The first and second bodies 115, 120 of the first object 105 may then be joined to reform the first object 105.

When the first and second objects 105, 110 are joined, the objects 105, 110 combine to form a first toy. When the first and second objects 105, 110 are not joined, the first object 105 may form a second toy when its first and second bodies 115, 120 are joined. Similarly, when the first and second objects 105, 110 are not joined, the second object 110 forms a third toy. Thus, the first and second objects 105, 110 used to form the pet toy provide at least three distinct toys for the animal to play with.

The second object 110 may be sufficiently sized and/or sufficiently flexible to conform, wholly or partially, to the shape of the first object 105 when the first and second objects 105, 110 are joined and a user grips the first and second objects 105, 110. Such conformation may facilitate the user grasping the first object 105. A user may grasp the joined first and second objects 105, 110 to throw them when playing a game with the animal, such as fetch.

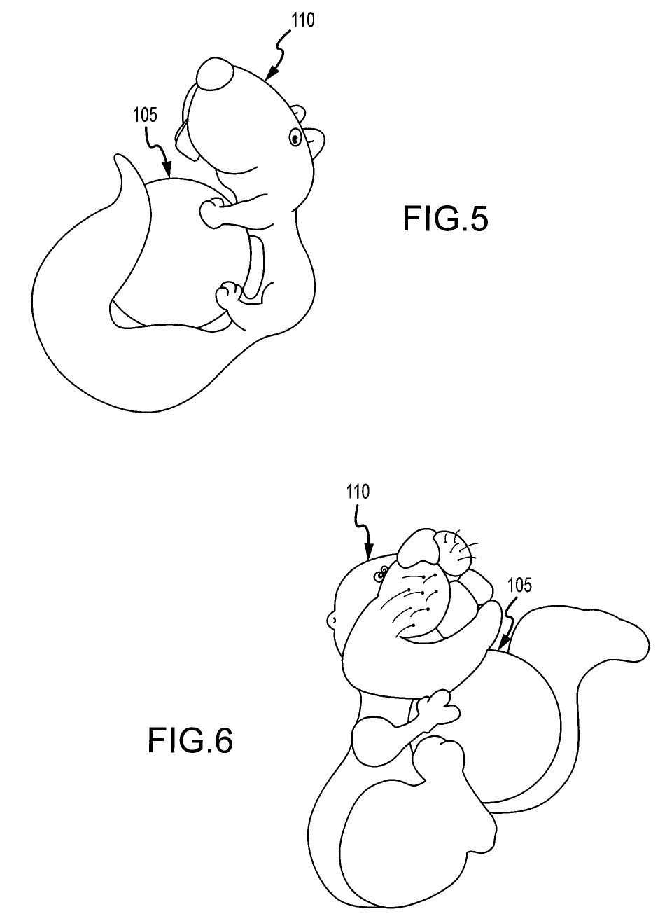

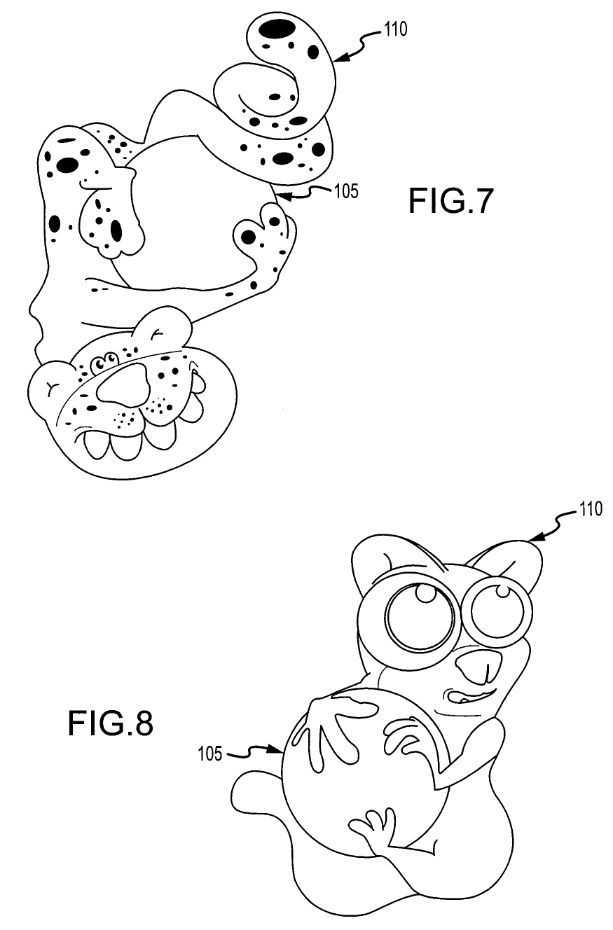

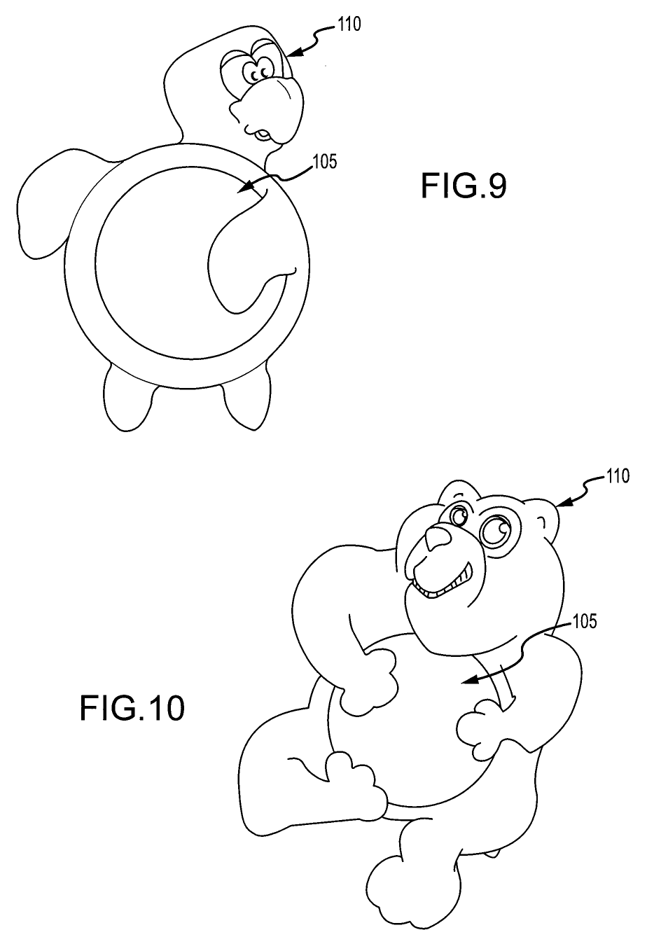

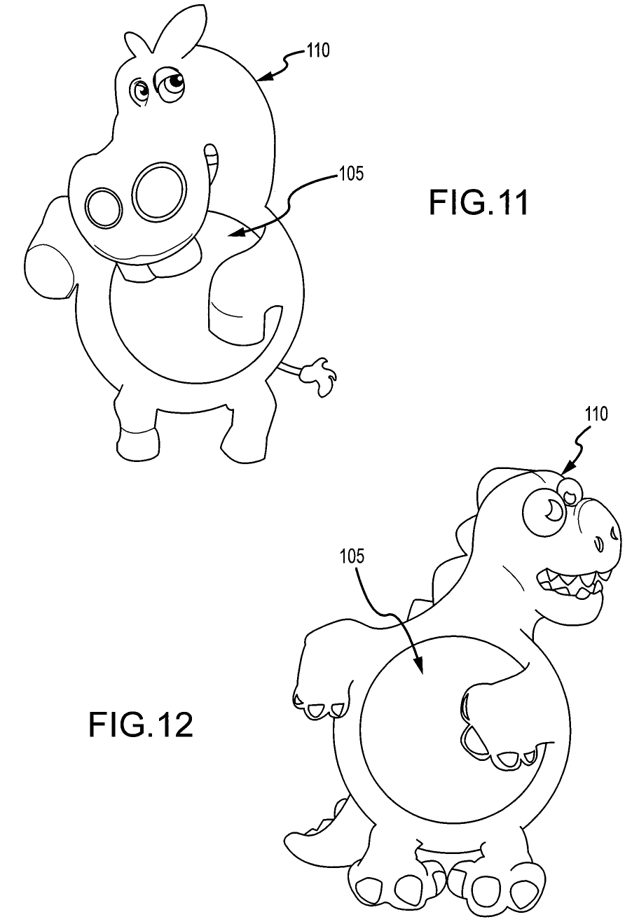

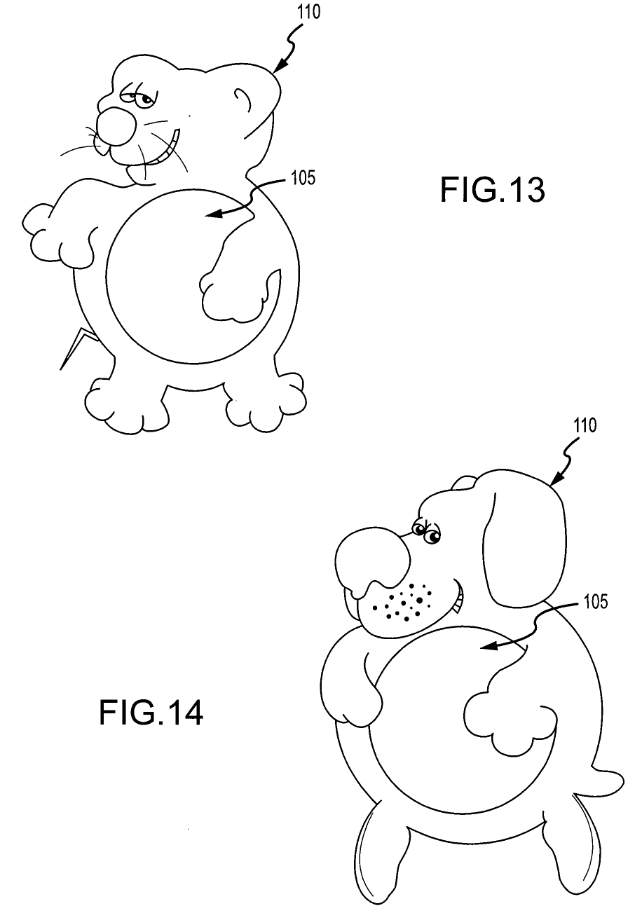

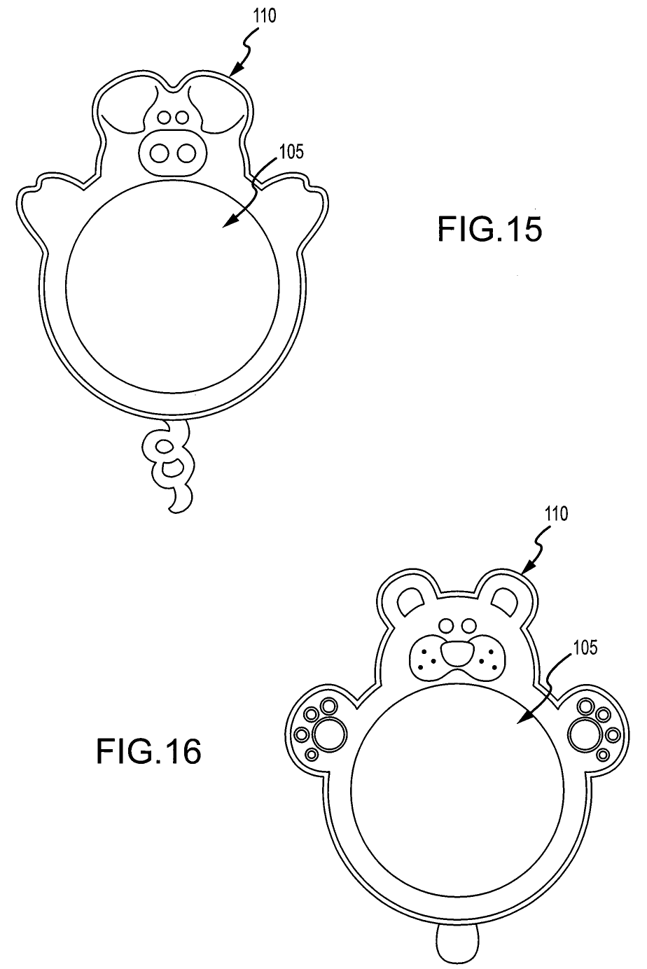

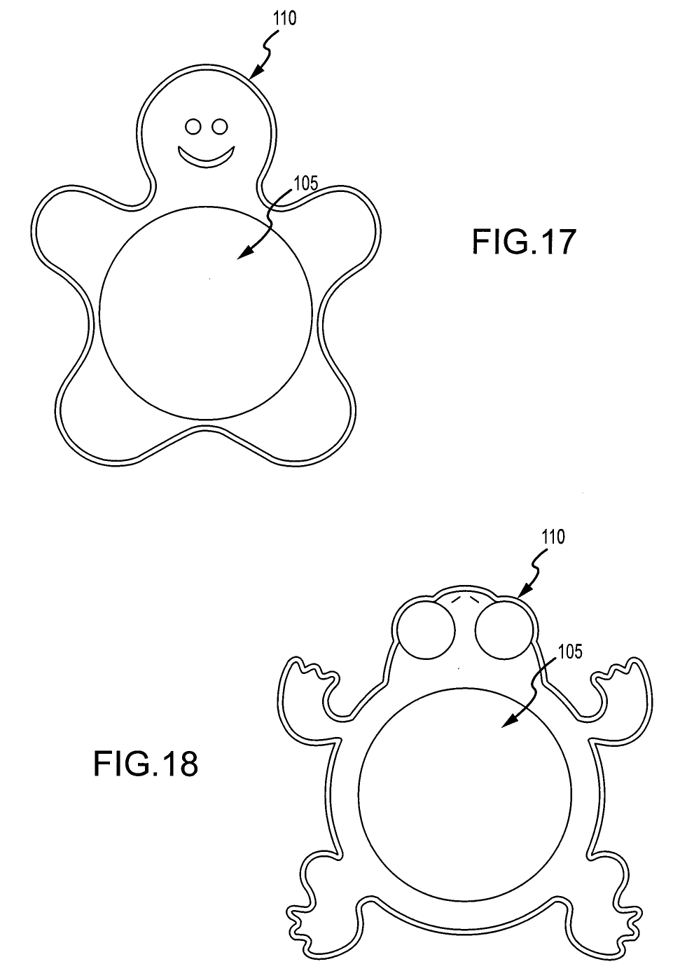

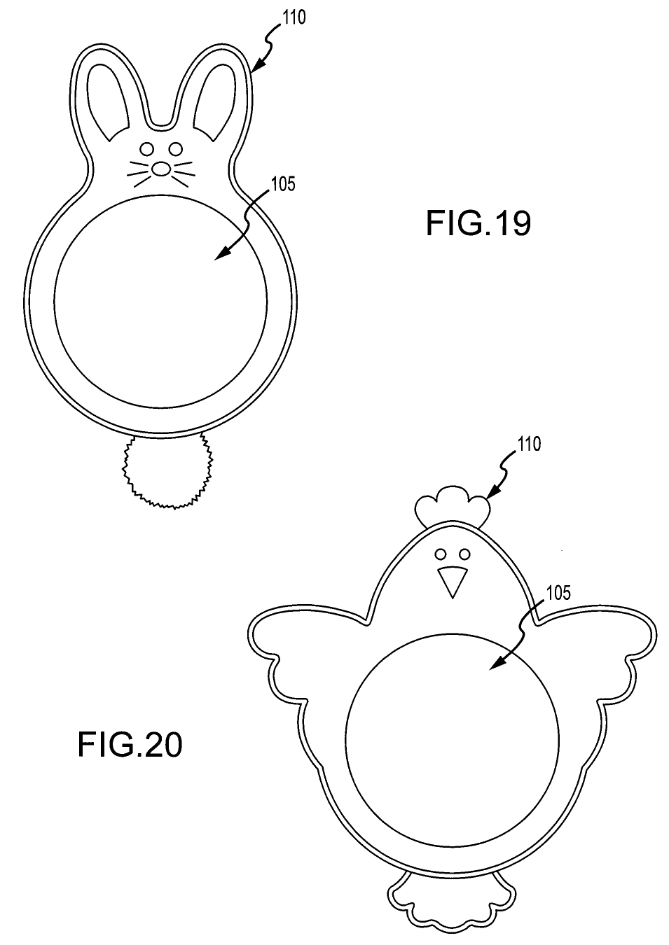

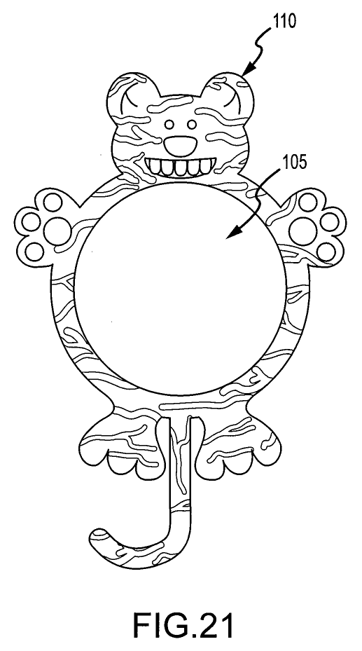

FIGS. 5-14 depict various other embodiments of a pet toy. These embodiments are similar to the first embodiment of the pet toy shown in FIGS. 1-4. More particularly, each embodiment like the first embodiment may include first and second objects 105, 110. Also like the first embodiment of the pet toy, the first object 105 for each embodiment may be a ball or the like and may include a groove. Also, like the first embodiment of the pet toy, the second object 110 for each embodiment depicted in FIGS. 5-14 may be a toy formed from a plush or non-plush body, which may or may not be stuffed. The plush or non-plush body may resemble an animal, such as a squirrel as shown in FIG. 5, a beaver as shown in FIG. 6, a cheetah as shown in FIG. 7, a bush baby as shown in FIG. 8, a turtle as shown in FIG. 9, a bear as shown in FIG. 10, a horse as shown in FIG. 11, a dinosaur as shown in FIG. 12, a mouse as shown in FIG. 13, a dog as shown in FIG. 14, a pig as shown in FIG. 15, another bear as shown in FIG. 16, a gingerbread man as shown in FIG. 17, a frog as shown in FIG. 18, a rabbit as shown in FIG. 19, a bird as shown in FIG. 20, and a tiger as shown in FIG. 21. The first and second objects 105, 110 for each embodiment depicted in FIGS. 5-21 may be selectively joined and disconnected in a manner similar to the one described above for the first embodiment of the pet toy 100.

The first and second objects 105, 110, or any other component, of the pet toys may include a palatability enhancer. The palatability enhancer may be embedded within or coated on the bodies, fabrics or other materials that form the pet toy. Further, the palatability enhancer may be uniformly distributed throughout or on such bodies, fabrics or other materials, or concentrated in one or more areas within or on them. A more uniform distribution may be used to attract the animal equally to the various regions of the components of the pet toy that include the palatability enhancer. Concentrating the palatability enhancer in one or more predetermined regions may focus the animal's attention on specific portions of components of the pet toy that include the palatability enhancer.

The palatability enhancer may be any substance that generally triggers a chemical reaction in an animal that causes it to continue to chew, lick, eat, or otherwise play with the pet toy. The palatability enhancer may also emit an odor that initially attracts the animal to the pet toy. Palatability enhancers may be made wholly or partially from meat or poultry broth concentrate or spray-dried powder, hydrolyzed proteins, yeast and/or yeast extract, liver, or any combination such ingredients. One suitable palatability enhancer is 6C2 enhancer, supplied by Applied Food Biotechnology International, Inc. of St. Charles, Mo.

Any components of the pet toys may incorporate scents attractive to animals to attract the animal to the pet toy. Such scents may be noticeable by, and less pleasing to, humans. One such exemplary scent is Givaudan 96625332 Spearmint. Palatability enhancers may also emit odors attractive to animals but less pleasing to humans. To hide such odors from detection, the pet toy may further include a masking scent such as vanilla, mint, or the like. The masking scent may be sufficiently concentrated to mask the odors emitted from palatability enhancers and animal attraction scents from detection by humans while not masking these odors from animals, which generally have a keener sense of smell. In other words, the odors that may be unpleasing to humans remain detectable to the animal to attract the animal to the pet toy but masked from detection by humans by a second odor.

Like the palatability enhancer, the masking scent may be embedded within or coated on the bodies, fabric sheets or other components of the pet toys. The masking scent may be uniformly distributed throughout or on such bodies, fabric sheets, or other components, or concentrated in one or more areas within them. A more uniform distribution may be used to maintain the masking scent within the pet toy as the animal consumes the pet toy or separates it into multiple, independent portions.

Any bodies, fabric sheets or other components of the pet toy may include other optional substances such as dental cleaning agents, flavoring agents, colorants, breath freshening agents, and the like embedded within or coated on these bodies or other components. A phosphate may be a suitable dental cleaning agent. Suitable breath-freshening agents may include parsley, kelp, or some combination thereof. Likewise, suitable flavoring agents may include garlic, meat flavoring (such as juices, pastes or powders), cheese flavors, fruit flavors, smoke flavors, or any combination thereof. Suitable colorants may include natural or synthetic dyes or pigments.

One or more ropes or the like may be attached or joined to the pet toy. Any such ropes may be joined to the first object 105, the second object 110, or to both. A rope may be used to provide flossing or other dental care for the animal, to play tug-of-war with the animal, or to provide an object for a person to hold to avoid touching the pet toy when picking it up or throwing it for retrieval by the animal.

Although potential shapes of the first and second objects 105, 110 of the pet toy are described above and depicted in FIGS. 1-21 with certain specificity, each object 105, 110 may be formed into other suitable shapes, including, but not limited to, geometric shapes (e.g., a square, a cube, a star, a disc, and so on), food (e.g., a carrot, a tomato, an apple, a banana, and so on), tools (e.g., a hammer, a screwdriver, a saw and so on), other animals (e.g., an octopus, a shark, and so on) and other objects (e.g., rock, volcano, tree, and so on). Further, although the first and second objects 105, 110 are described above as being formed from different materials, each object 105, 110 could be made, wholly or partially, from the same type of material. For example, the first and the second objects 105, 110 could each be made, either partially or wholly, from rubber. As another example, the first and second objects 105, 110 could each be made, either partially or wholly, from fabric. The foregoing examples are merely illustrative and are not intended to limit use of other appropriate materials, or combinations of materials, from the first and second objects 105, 110.

Providing objects 105, 110 made of similar materials creates a pet toy in which the objects 105, 110 forming the pet toy have a similar texture or feel. Providing objects 105, 110 made of different types of materials creates a pet toy in which the objects 105, 110 forming the pet toy have different texture or feel. When the objects 105, 110 for the pet toy are formed from different types of materials, the different texture or feel of the objects 105, 110 may result in variety chewing experiences for the animal.

It should be noted that all directional references set forth herein (e.g., upper, lower, upward, downward, left, right, leftward, rightward, top, bottom, above, below, vertical, horizontal, clockwise, and counterclockwise) are relative and only used for identification purposes to aid the reader's understanding of the embodiments of the present invention, and are not limitations, particularly as to the position, orientation, or use of the invention unless specifically set forth in the claims. References to any joinder of elements (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A pet toy comprising:
a first object comprising a first toy;
a second object comprising a second toy; and
the second object selectively joined to the first object to form a third toy and selectively disconnected from the first object to deconstruct the third toy.

2. The pet toy of claim 1, wherein the first toy comprises a ball.

3. The pet toy of claim 1, wherein the first toy includes a groove.

4. The pet toy of claim 3, wherein at least a portion of the second toy is received within the groove when the first and second objects are joined.

5. The pet toy of claim 1, wherein the second toy comprises at least one of a plush toy and a non-plush toy.

6. The pet toy of claim 1, wherein the first toy comprises a first body and a second body, the first body selectively engaged with the second body to form the first toy.

7. The pet toy of claim 6, wherein the first body includes a shaft and the second body defines an open space sized to receive the shaft.

8. The pet toy of claim 7, wherein receipt of the shaft within the open space engages the first body with the second body.

9. The pet toy of claim 7, wherein the second toy includes a hole sized to receive the shaft therein.

10. The pet toy of claim 9, wherein the shaft is received within the hole to join the first and second objects.

11. A pet toy comprising:
a ball;
a plush body; and
the ball may be selectively joined to the plush body and selectively disconnected from the plush body.

12. The pet toy of claim 11, wherein the ball includes a groove.

13. The pet toy of claim 12, wherein at least a portion of the plush body is received within the groove when the ball is joined to the plush body.

14. The pet toy of claim 11, wherein the ball defines a cavity.

15. The pet toy of claim 11, wherein the ball includes a first body and a second body, the first body selectively engaged with the second body to form the ball.

16. The pet toy of claim 15, wherein the first body includes a shaft and the second body defines an open space sized to receive the shaft.

17. The pet toy of claim 16, wherein receipt of the shaft within the open space engages the first body with the second body.

18. The pet toy of claim 17, wherein the plush body includes a hole sized to receive the shaft therein.

19. The pet toy of claim 18, wherein the shaft is received within the hole to join the ball and the plush body.

20. The pet toy of claim 11, wherein the plush body comprises a stuffed animal.
